(19) United States
(12) Patent Application Publication
(10) Pub. No.: US 2006/0101690 A1
(43) Pub. Date: May 18, 2006

(54) Real estate sign apparatus

(76) Inventor: Robert P. Terbet JR., Raleigh, NC (US)

Correspondence Address: WITHROW & TERRANOVA, P.L.L.C., P.O. BOX 1287, CARY, NC, 27512, US

(21) Appl. No.: 10/988,378

(22) Filed: Nov. 12, 2004

(51) Int. Cl. G09F 15/00

(52) U.S. Cl. 40/607.09

(57) ABSTRACT

A real estate sign for advertising real estate that includes an extension arm to support attachment devices, such as additional placard holders or a brochure box, without any fasteners, permanent attachments, or other fastening devices in order to facilitate quick, easy and convenient use of attachment devices with real estate signs. The real estate sign is comprised of a frame having three or more sides forming a groove inside the frame for holding a main placard inside the frame to display advertising or other information. The real estate sign includes at least one leg attached to the frame that supports the frame when the leg is inserted into the ground, and at least one extension arm attached to the frame to support an attachment device without any fasteners. The attachment devices include a socket member that is adapted to fit onto the extension arm to securely attach the attachment device to the frame of the sign without fasteners or permanent attachment devices.

### FIELD OF THE INVENTION

The present invention is related to a real estate sign apparatus for holding and securing an advertising placard and/or a brochure box.

### BACKGROUND OF THE INVENTION

Signs are used for advertising in a variety of contexts and applications. The real estate industry is particularly known for using advertising signs prominently to promote the sale and lease of residential and commercial property. A real estate agent typically places an advertising sign on the property being listed for sale or lease.

Real estate advertising signs are typically made of steel or iron and are driven into the ground to be made secure. The sign typically includes two legs with sharpened ends on the lower portion of the legs so that the legs of the sign can be driven into the ground by applying force downward on the sign. Agents typically apply downward force to the top of the frame of the sign or push a support post attached to the sign downward into the ground.

A real estate sign will typically include a large main placard placed inside the metal frame of the sign and held into place. The main placard typically provides information about the listing agent of the real estate, such as the name of agent's real estate agency, the name of the agent, and contact information such as a phone number and web site domain name uniform resource locator (URL), for example.

The sign may also contain additional holders for other placards indicating a status, such as “SOLD” or “SALE PENDING.” Providing additional placards on the real estate sign can be advantageous to keep the public informed of additional information or status of a property being advertised. For example, if a property has been sold, providing an additional placard indicating a “SOLD” status informs other interested buyers that the property has been sold and thus saves the listing agent's time in not having to field additional calls regarding the property. Additional placards can also be used to personalize and/or provide additional information that either does not lend itself to the main placard or will not fit on the main placard.

If additional placard holders are provided, they are either permanently attached to the real estate sign or attached using a fastener means, such as a clamp and bolt or other fastener system. In the case of attachable holders, real estate agents must use tools to attach and detach the holders to the real estate sign thereby making the installation and removal of real estate signs cumbersome and time consuming.

The agent also typically provides specific information relating to the real estate being advertised for sale or lease proximate to the agent's real estate sign. This information, typically in the form of a flyer or brochure, includes the sale or lease price, the address, pictures, and other specific information or features of the property. It is typical that a separate brochure box is provided that contains flyers or brochures containing additional valuable information about the property that is retrievable by interested potential buyers or lessees. This allows the main placard sign to be generic to the agent and not include specifics about the property advertised, so that the main placards can be used over and over again, while information specific to the property is made available in the separate brochure box.

The brochure box typically contains a lid that is opened to gain access internally to the box where the brochures are located. The lid provides cover to the brochures from weather. The brochure box is either placed beside the real estate sign on a separate supporting post, or mounted onto the real estate sign. If the brochure box is mounted on the real estate sign, the brochure box is mounted to the frame of the sign using a clamp and bolt or other fastener system similar to that of additional placard holders. Again, the real estate agent or person that is installing or removing the brochure box must use tools to install and remove the brochure box thereby adding complexity and inconvenience to the process.

As stated above, real estate signs typically provide for the ability to install optional attachments for holding additional placards and/or brochure boxes. These additional attachments are extremely valuable. The attachments allow agents to provide additional information specific to the property as well as provide status information to make more efficient use of the agent's time. However, the advantage in using these optional attachments is offset in part due to the cumbersome and time consuming installation that is required. The attachments must either be mounted to the sign using fastener means that require use of tools, or the agent must provide separate mounting posts, each adding expense and inefficient use of time in installation and de-installation. Sometimes, due to hardware failures or due to some real estate agents not being particularly mechanically inclined, the attachments are not attached at all, resulting in loss of the benefit of such attachments.

Therefore, there exists a need to provide a real estate sign that provides for the use of additional attachment devices, such as placard holders and/or brochure boxes, without requiring tools and time consuming actions to install and de-install such optional attachments to the real estate sign. At a minimum, the invention will provide time savings and cost savings in terms of eliminating the need for tools and fasteners for the installation and de-installation of optional attachments to the real estate sign. The invention may also provide additional benefit to those that either cannot or will not use attachments to real estate signs due to their cumbersome nature in being installed and de-installed using fastener means.

### SUMMARY OF THE INVENTION

The present invention relates to a real estate sign that includes an extension arm to support attachment devices, such as additional placard holders or a brochure box, without any fasteners, permanent attachments, or other fastening devices in order to facilitate quick, easy and convenient use of attachment devices with real estate signs.

The present invention includes a real estate sign comprising a frame having three or more sides for placement of a main placard inside the frame and held in place with sections to display advertising or other information. The sign may include at least one leg attached to the frame that supports the frame when the leg is inserted into the ground, and at least one extension arm attached to one of the three more sides of the frame wherein the at least one extension arm comprises a socket member adapted to support an attachment device without any fasteners. The frame of the sign may be constructed out of a material comprised from the group consisting of metal, iron, steel, aluminum, and plastic.

The real estate sign may comprise two legs and further comprises a support member having two ends wherein one end is attached to one of the two legs, and the other end is attached to the other of the two legs. The extension arm may comprise an attachment section having two ends, wherein the attachment section is attached to the frame on one end of the attachment section. The attachment section may be substantially perpendicular to a socket member on the other end of the attachment section.

The real estate sign may comprise a bottom placard holder having two ends wherein the first end is attached to one of the two legs of the sign and the other end is attached to the other of the two legs of the sign. The bottom placard holder is designed to hold an additional sign other than the main placard held in place by the frame of the real estate sign, typically below the frame of the sign that holds the main placard.

The bottom placard holder may consist of a U-shaped frame that comprises a bottom side having two ends, a left side that is attached to one of the bottom side ends, and a right side parallel to the left side that is attached to the other of the bottom side ends. The sides of the holder may form a slot between the left side and the right side of the U-shaped frame, wherein the left side is attached to one of the two legs and the right side is attached to the other of the two legs. The bottom placard holder may be attached to the legs of the real estate sign in a plane that is parallel to the plane between the two legs. The bottom, left, and right sides of the U-shaped frame for the bottom placard holder may be comprised of rectangular strips of material that are bent inward on each side of the strip to form a groove adapted to hold a placard wherein the placard can be placed into the slot by placing the placard inside the groove between the left side and the right side.

The bottom placard holder alternatively may consist of a frame built-in to the sign, comprising a bottom side having two ends where one end is attached to one leg of the sign and the other end is attached to the other leg of the sign, and a top side having two ends that is parallel to the bottom side where one end is attached to one leg and the other end is attached to the other leg. A placard may be placed inside the bottom placard holder bound by the top side and bottom side and held into place with U-shaped members on the bottom and top sides and one of the legs.

The attachment device that is attached to the extension arm of the real estate sign may include an additional placard holder for holding additional placards on the real estate sign. The additional placard holder contains a socket member that is adapted to fit into the socket member attachment attached to the frame such that the frame supports the sign holder without any fastener. The additional placard holder may be comprised of a U-shaped frame comprising a bottom side having two ends, a left side that is attached to one of the bottom side ends, and a right side parallel to the left side that is attached to the other of the bottom side ends; wherein a slot is formed between the left side and the right side. A grove may be formed by the sides of the U-shaped frame like that of the bottom placard holder to hold an additional placard in place inside the additional placard holder.

Alternatively, the additional placard holder may be comprised of a built-in frame that is formed by a top side extending between the legs of the sign and a bottom side parallel to the top side extending between the legs whereby a groove is formed inside the top side and bottom side to hold a placard in the built-in frame. U-shaped members are attached to the top side, bottom side, and/or leg(s) to hold the bottom placard in place against the built-in frame.

The attachment device that is attached to the extension arm of the real estate sign may include a brochure box for holding brochures or flyers relating to the real estate being advertised. The brochure box is comprised of a box having a front side and a back side attached together to form a cavity and containing a socket member that is adapted to fit into the socket member attachment attached to the frame such that the frame supports the brochure box without any fastener. The brochure box may contain a hinge that is attached to the back side of the brochure box wherein the lid is attached to the hinge to secure the lid to the brochure box.

The socket member on the brochure box may be located on the back side of the brochure box. The socket member is adapted to be inserted onto the extension arm of the real estate sign to secure the brochure box to the real estate sign without fasteners.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 is an illustration of a real estate sign and removable attachments according to one embodiment of the present invention;

FIG. 2 is a left perspective view of the real estate sign illustrated in FIG. 1;

FIG. 3 is a right perspective view of the real estate sign illustrated in FIG. 1;

FIG. 4 is a rear view of the real estate sign illustrated in FIG. 1;

FIG. 5 is an illustration of the real estate sign in FIG. 1 with an alternative embodiment for the bottom placard holder;

FIG. 6 is a rear view illustration of the real estate sign illustrated in FIG. 6;

FIG. 7 is an illustration of the real estate sign illustrated in FIG. 1, without the removable attachments thereby exposing the extension arms in view;

FIG. 8 is an illustration of an extension arm of the real estate sign;

FIG. 9 is a rear perspective view of the removable brochure box attachment;

FIG. 10 is a side view of the removable brochure box attachment illustrated in FIG. 9;

FIG. 11 is a bottom view of the removable brochure box attachment illustrated in FIG. 9;

FIG. 12 is a perspective view of the removable side placard attachment;

FIG. 13 is a side view of the removable side placard attachment illustrated in FIG. 12; and

FIG. 14 is a bottom view of the removable side placard attachment illustrated in FIG. 12.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention is related to a real estate sign that provides extension arms to allow additional attachment devices, such as placard holders and/or brochure boxes, to be attached securely to the real estate sign without fasteners or other installation brackets or requiring tools for installation of such. As discussed above in the “Background of the Invention,” the present invention provides the benefit of allowing easier, more cost saving and time saving installation and de-installation of attachment devices to real estate signs.

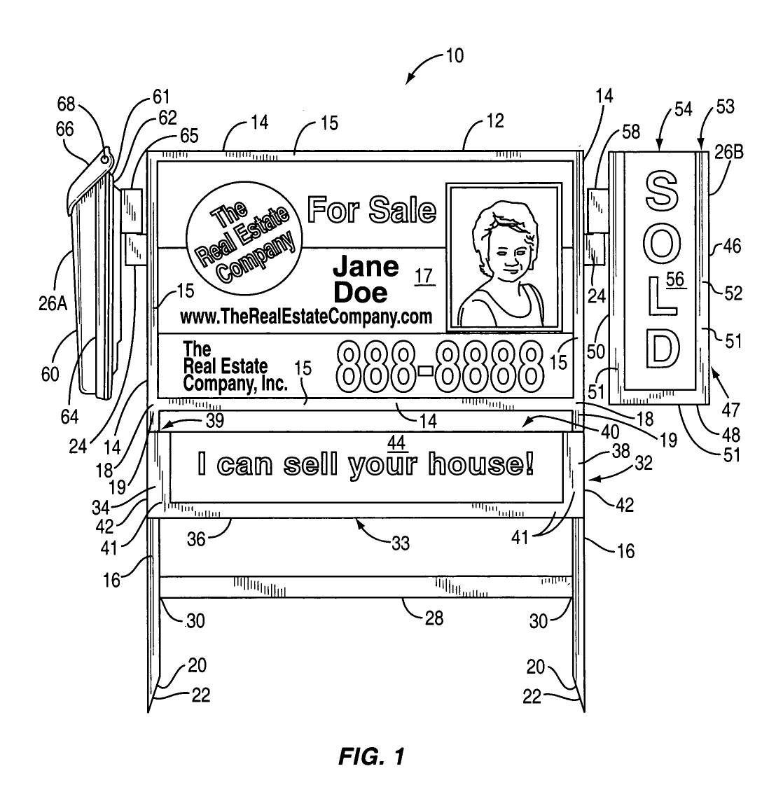

FIG. 1 illustrates a real estate sign 10 according to one embodiment of the present invention. The real estate sign 10 comprises a frame 12, which is typically constructed out of iron, steel or other rigid material that can withstand outside environmental conditions. The material used to construct the frame 12 is typically coated in a black powder paint to prevent rusting and to provide a texture that is commercially acceptable. The frame 12 is comprised of four individual rectangular strips of material that are bent inward on each side and attached together in a square section to form sides 14. In the real estate sign 10 illustrated in FIG. 1, the frame 12 has four sides, each labeled 14.

When the sides 14 are attached to each other to form the frame 12 as illustrated in FIG. 1, one of the sides of the rectangular strips of material that are used to construct the frame 12 is bent upward and inward to form bent sections 15, thereby creating a groove 39 (not shown in FIG. 1) all along the inside perimeter of the frame 12. The bent sections 15 are typically 0.75 inches wide and the groove 39 formed in between the bent sections 15 is typically 0.125 inches wide. Please note that, although the real estate sign 10 illustrated in FIG. 1 has a frame 12 comprised of four sides 14, the present invention is not limited to a four-sided real estate sign 10.

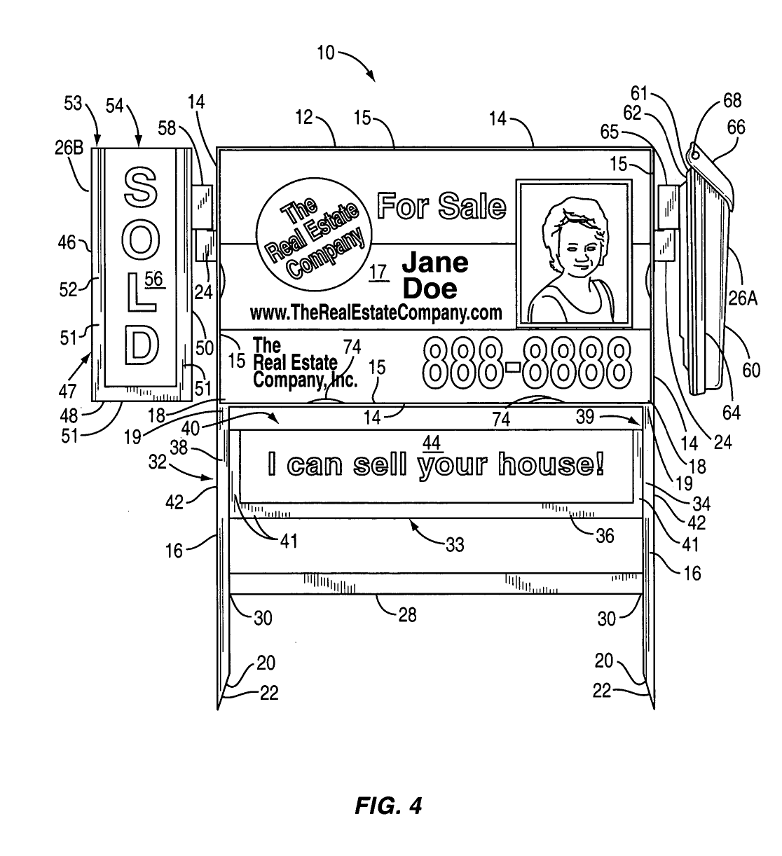

The placard 17 can be placed inside the groove 39 that is formed between the bent sections 15 of the sides 14. In the real estate sign 10 illustrated in FIG. 1, the placard 17 is placed inside the groove 39 by inserting the placard 17 on the back side of the frame into the grove 39. The placard 17 is held into place against the from side of the frame 12 with U-shaped members 74 attached to the sides 14 of the frame 12 (illustrated in FIG. 4). Therefore, the width of the placard 17 must be less than the width of the sides 14 of the frame 12 in order for the placard 17 to fit inside the frame 12.

One or more legs 16 are provided and attached to the base 18 of the frame 12. The legs 16 are comprised of a first end 19 and a second end 20. A first end 19 of each leg 16 is attached to the base 18 of the frame 12 to support the real estate sign 10. Typically, the second end 20 of each leg 16 is inserted into the ground, thereby supporting the frame 12. The second end 20 of each leg 16 usually contains a sharpened section 22 so that the legs 16 can be driven into the ground more easily.

In accordance with the present invention, the real estate sign 10 illustrated in FIG. 1 also contains one or more extension arms 24 that are used to support attachment devices 26. In FIG. 1, two attachment devices 26 are illustrated as being attached to the real estate sign 10. The first attachment device 26 is a brochure box 26A, and the second attachment device 26 is an additional placard holder 26B. The attachment devices 26A, 26B, as well as the extension arms 24, allow attachment of the attachment device 26 without fasteners, clamps or other hardware. It is the ability of the real estate sign 10 to support attachment devices 26 using one or more extension arms 24 without fasteners or permanent type fixtures that is the essence of the invention, and is discussed later in this application.

The real estate sign 10 illustrated in FIG. 1 includes a support member 28 that extends and is attached from one leg 22 to the other leg 22 to provide additional support for the legs 22 and the frame 12. Additionally, the support member 28 can be used to drive the legs 16 of the real estate sign 10 into the ground during installation. One can apply force, such as using one's foot, downward on the support member 28 to drive the legs 16 downward into the ground. The support member 28 is attached to the legs 16 and ends 30.

The real estate sign 10 illustrated in FIG. 1 also includes a bottom placard holder 32 that is provided by a U-shaped frame 33. The U-shaped frame 33 is comprised of rectangular strips of material forming a left side 34, a bottom side 36, and a right side 38. The material used to construct the frame 12 of the real estate sign 10 may also be used to construct the U-shaped frame 33 of the bottom placard holder 32. Just as for frame 12, the rectangular strips that provide the left side 34, the bottom side 36, and the right side 38 of the bottom placard holder 32 are bent upward to form bent sections 41 to form a groove 39 (not shown in FIG. 1) internal to the bent sections 41 along the inside perimeter of the sides 34, 36, 38. The space formed between the left side 34 and the right side 38 along with the groove 39 forms a slot 40 in which a bottom placard 44 may be inserted to be supported by the real estate sign 10. Once the bottom placard 44 is inserted into the slot 40, the bottom placard 44 rests in the groove 39. The bottom placard holder 32 is attached to the legs 16 of the real estate sign 10 in the embodiment illustrated in FIG. 1 at attachment points 42, which may include welding of the bottom placard holder 32 to the legs 16. Additionally, the bottom placard holder 32 may be molded into the legs 16 such that the bottom placard holder 32 and legs 16 form one continuous molded piece.

As previously referenced, one attachment device 26 that may be attached to the real estate sign 10 is the additional placard holder 26B. The additional placard holder 26B is illustrated in FIG. 1, and is illustrated as holding a “SOLD” sign placard 56. The additional placard holder 26B is formed by a U-shaped frame 47 similar to the U-shaped frame 33 that forms the bottom placard holder 32. The U-shaped frame 47 is formed as a result of rectangular strips of material, such as iron or steel, being used to form a left side 50 connected to a bottom side 48, which is connected to a right side 52, as illustrated in FIG. 1, like that of the bottom placard holder 32. Again, the rectangular strips of material forming the bottom side 48, left side 50, and right side 52 are bent upward to form bent sections 51 to form a groove 53 (not shown in FIG. 1) inside the bent sections 51 along the inside perimeter of the sides 48, 50, 52. The grooves 53 on each side of the left side 50 and right side 52 form a slot 54 in which the additional placard 56 can be inserted. The width of the additional placard 56 must be less than the width of the space between the left side 50 and right side 52, including the width of the groove 53 within the left side 50 and the right side 52 so that the placard 56 can fit inside the groove 53.

The additional placard holder 26B includes a socket member 58 that is used to attach the additional placard holder 26B to the extension arm 24 of the real estate sign 10, as will be described later in this application. This socket member 58 attachment allows the additional placard holder 26B to be attached securely to the real estate sign 10 and frame 12 without any clamps or other fastening devices, which provides an advantage over the prior art in terms of cost, convenience, and time savings as previously referenced in the “Background of the Invention” section of this patent application.

Another attachment device known as a “flyer box” or “brochure box” 26A is also shown as being attached to the real estate sign 10 in FIG. 1. It is desirable to provide a brochure box 26A on a real estate sign 10 so that more specific information about the real estate being advertised for sale or lease can be included on the real estate sign 10 for access by interested buyers and/or lessees. As illustrated in FIG. 1, the brochure box 26A includes a front side 60 and a back side 62. The front side 60 and the back side 62 are bonded together on their edges to form a cavity 64. When the front side 60 and the back side 62 are bonded together, the cavity 64 is bound on all sides except the top 61 of the brochure box 26A. Just as with the additional placard holder 26B, the brochure box 26A is attached to the real estate sign 10, and more particularly to the frame 12 of the real estate sign 10, using a socket member 65 that forms part of the brochure box 26A. A more detailed description of the socket member 65 and how it attaches to the extension arm 24 to affix the brochure box 26A to the real estate sign 10 is discussed later below in this application.

The brochure box 26A in FIG. 1 also includes an optional lid 66 that is attached to the back side 62 of the brochure box 26A via a hinge 68. In this manner, one desiring to gain access to the cavity 64 of the brochure box 26A, where flyers or other brochures or information concerning the real estate being advertised are located, can gain access by lifting the lid 66 to access the cavity 64.

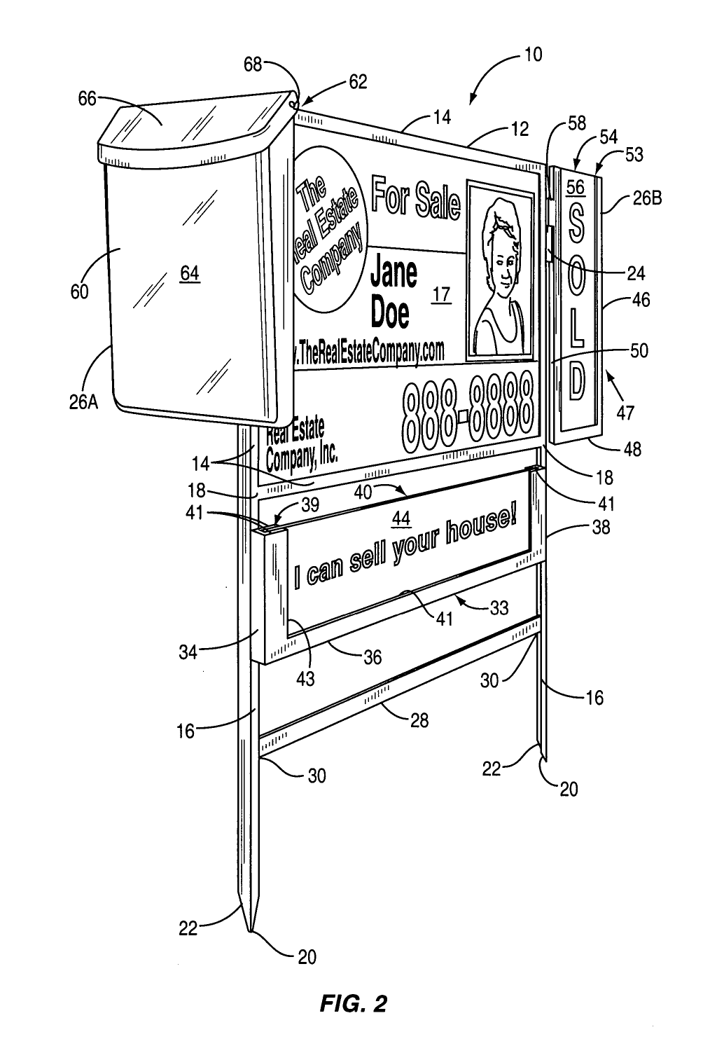

FIG. 2 illustrates a left perspective view of the real estate sign 10 illustrated in FIG. 1 to show additional features of the real estate sign 10 that were referenced, but not illustrated in FIG. 1. As illustrated in FIG. 2, the bottom placard holder 32 is shown where one can see the bent sections 41 of the left side 34, the bottom side 36, and the right side 38. As described above, the left side 34, bottom side 36, and right side 38 are comprised of rectangular strips of material, such as iron or steel, that are bent inward as shown in FIG. 2 to form bent sections 41 along the inside perimeter of the sides 34, 36, 38. This forms a groove 39 that can be used to secure a bottom placard 44 inside the bottom placard holder 32. Since the bottom placard holder 32 is U-shaped with a slot 40 formed by not attaching a member at the top between the left side 34 and the right side 38 and by providing grooves 39, a bottom placard 44 can be inserted into the slot 40 and held in place in the bottom placard holder 32. It is important that the bottom placard 44 be of a width that is less than the distance between the inside groove of the left side 34 and the inside groove 39 of the right side 38, but a width greater than the distance between the inner edges 43 of the bent sections 41 of the left side 34 and right side 38 so that the bottom placard 44 remains held in place within the groove 39 on all three sides 34, 36, 38 of the bottom placard holder 32.

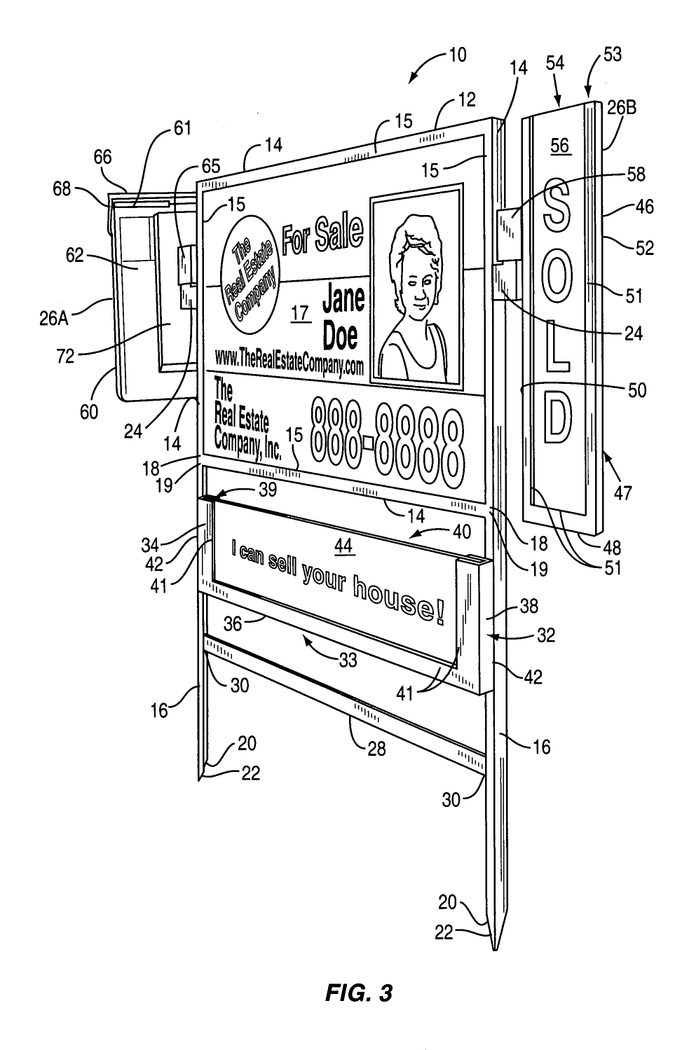

FIG. 3 illustrates a right perspective view of the real estate sign 10 illustrated in FIG. 1 to show the back side 62 of the brochure box 26A. As shown in FIG. 3, the back side 62 of the brochure box 26A includes a socket member platform 72 that is used to attach the socket member 65 to the back side 62 of the brochure box 26A. A socket member platform 72 may be necessary if there is not a solid surface on the back side 62 of the brochure box 26A to which the socket member 65 is securely and evenly mounted. However, the socket member platform 72 is an optional piece of the brochure box 26A that is not necessarily needed to be included to accomplish the present invention. In order to attach the brochure box 26A to the sign 10, the socket member 65 is placed on top of the extension arm 24 as will be discussed below in more detail.

FIG. 4 illustrates a rear view of the real estate sign 10 illustrated in FIG. 1. The purpose of illustrating FIG. 4 is to show the U-shaped attachment sections 74 that are used to hold and steady the main placard 17 against the inside of the frame 12. These U-shaped attachment sections 74 may be provided on one or more of the sides 14 of the frame 12 of the real estate sign 10.

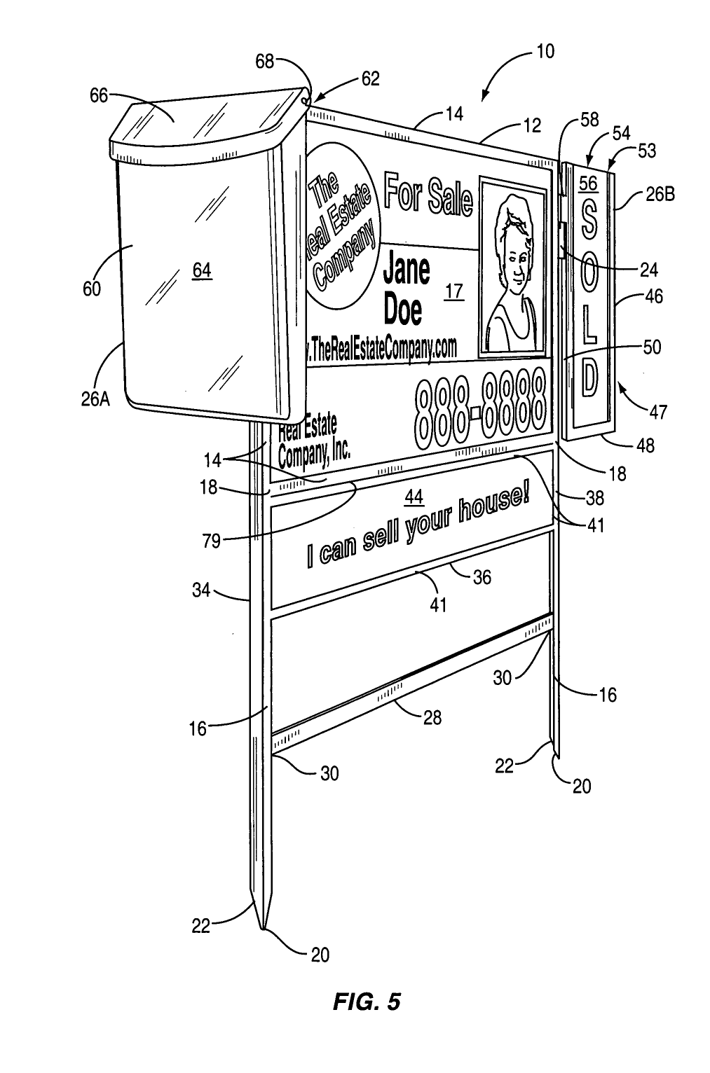

FIG. 5 illustrates an alternative embodiment of the bottom placard holder 32 that may be used with the present invention in the real estate sign 10. As illustrated in FIG. 5, the bottom placard holder 32 is not attached as a separate member on the legs 16 of the real estate sign 10 like illustrated in FIGS. 1-4. Instead, the bottom placard holder 32 is located in the same plane as the frame 12 and legs 16 of the real estate sign 10. The bottom placard holder 32 is formed by a built-in frame formed by a bottom side 36 and a top side 79. The bottom and top sides 36, 79 of the bottom placard holder 32 are formed by a piece of steel, iron or other material each having two ends with one end attached and extending from one leg 16 perpendicularly to the other end attached to the other leg 16 of the real estate sign 10.

The bottom placard holder 32 illustrated in FIG. 5 includes a top side 79 that may include bent sections 41 as previously described to form part of the groove 39 (not shown in FIG. 5) that runs along the inside perimeter of the top side 79 and bottom side 36, similar to the groove 39 in FIG. 2.

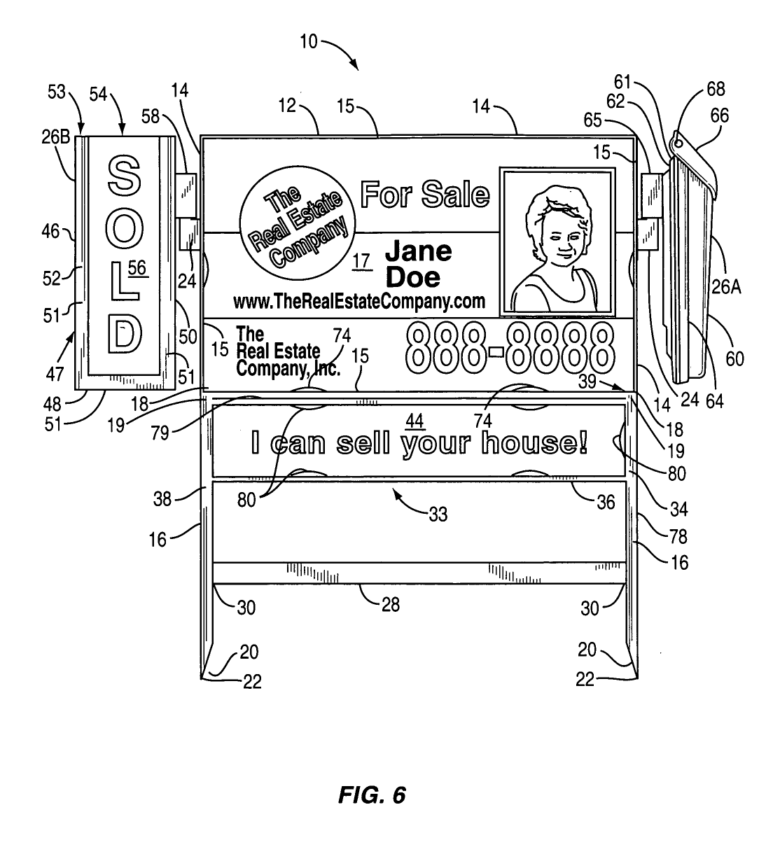

FIG. 6 illustrates the back side of the real estate sign 10 illustrated in FIG. 5 only to show that U-shaped members 80 are included on the top side 79, the bottom side 36, and a leg 16 to hold the bottom placard 44 in place inside the bottom placard holder 32 formed and bounded by by the bottom side 36 the top side 79, and the legs 16 as previously discussed above. The bottom placard 44 is placed into the bottom placard holder 32 from the side and slid from the left side of the bottom placard holder 32 to the right side of the bottom placard holder 32, as illustrated in FIG. 6 such that the placard 44 is inside the U-shaped members 80. The U-shaped member 80 attached to a leg 16 may be placed on either leg 16.

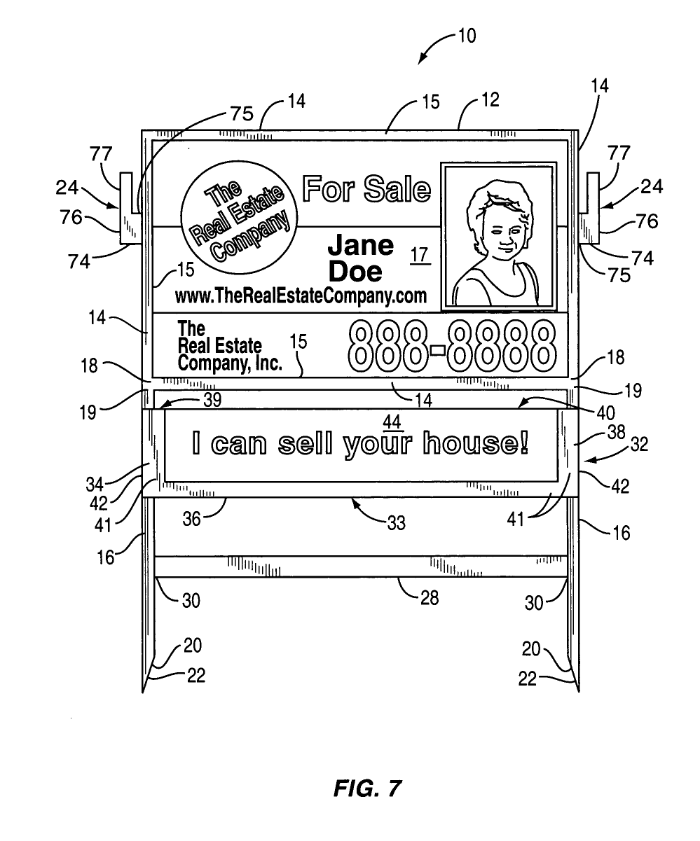

FIG. 7 illustrates the real estate sign 10 illustrated in FIG. 1 without the attachment devices 26 included so that the extension arms 24 are more clearly illustrated. The extension arms 24 are comprised of a first attachment section 74 that is substantially perpendicular to a socket member attachment 77. One end of the attachment section 74 is attached to the frame 12 of the real estate sign 10 on one side 14 at a first attachment end 75. A second attachment section end 76 of the extension arm 24 is attached to the socket member attachment 77. The socket member attachment 77 may be a male or female connection, and may be any shape or size that is substantially similar or the same as the size and shape of the socket members 58, 65 of the attachment devices 26A, 26B so that the attachment devices 26A, 26B can be placed onto the extension arms 24 and supported by the real estate sign 10 in a secure manner, as will be described later below in this application.

FIG. 8 provides an even closer view of the extension arm 24 that is part of the frame 12 of the real estate sign 10. Note that the extension arm 24 can be placed on any side 14 of the frame 12 of the real estate sign 10 that is desired. In the preferred embodiment of the present invention, the width between the outer edge of the side 14 to which the extension arm 24 is attached and the socket member attachment 77 is approximately 0.5 inches; however, the present invention is not limited to any particular spacing. The width of the socket member attachment 77 is shown as ‘w’ in FIG. 8.

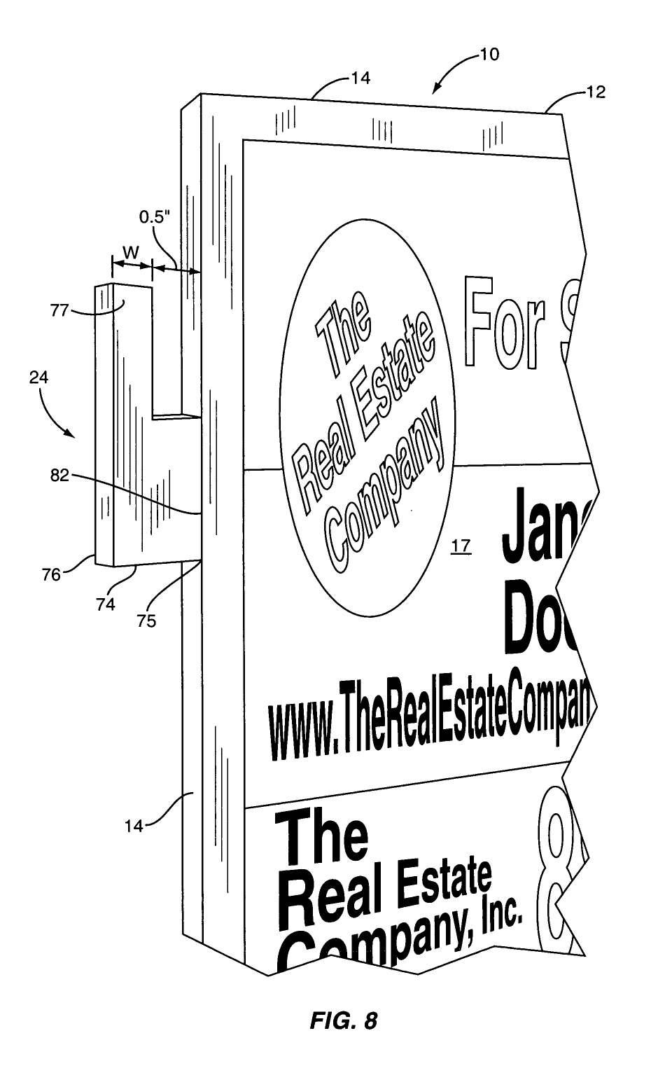

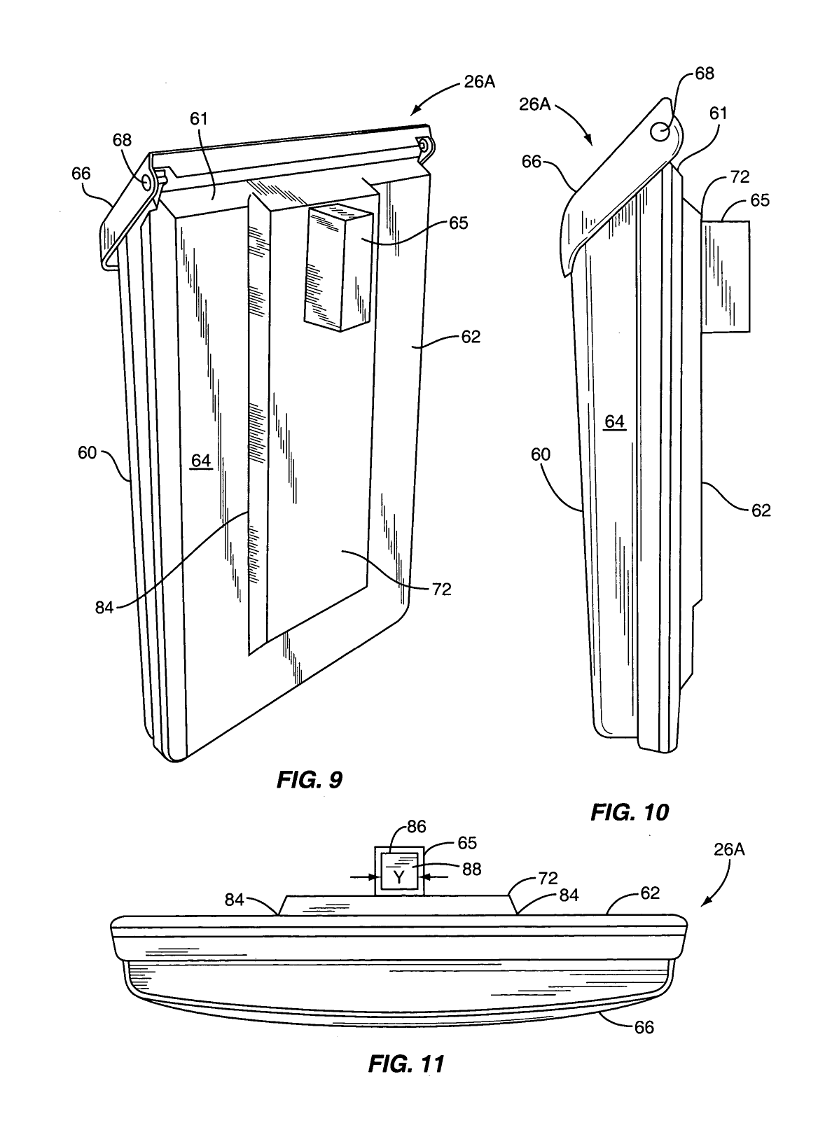

FIG. 9 illustrates a rear perspective view of the brochure box 26A to better disclose the preferred embodiment of the present invention. Again, as previously described above, a socket member platform 72 is attached to or molded integral with the back side 64 of the brochure box 26A. A socket member 65 is attached to the back side of the socket member platform 72. FIG. 10 illustrates a side view of the brochure box 26A showing the socket member 65 extending outward from the socket member platform 72. FIG. 11 shows a bottom view of the brochure box 26A and the socket member 65. As illustrated in FIG. 11, the socket member 65 contains an orifice 88 that is formed by a square-shaped cylinder forming an outer perimeter 86. In this manner, the socket member 65 forms a female connection in which the orifice 88 is placed on top of the socket member attachment 77 to form a mating connection such that the brochure box 26A is supported by the socket member attachment 77 without any fasteners or other external attachment devices like illustrated in FIGS. 1-4. Note that the socket member 65 could be a male member if the socket member attachment 77 is a female member so that socket member attachment 77 can be placed on the socket member 65.

Preferably, the width of the orifice 88, indicated as width ‘y,’ will be only slightly greater than the width of the socket member attachment 77, indicated as width ‘w’ in FIG. 8. In the embodiment illustrated in FIG. 8, the socket member attachment 77 is a square, meaning that all sides are of equal width, and in the preferred embodiment, only slightly greater than the width of ‘y.’ However, please note that any shape may be provided for orifice 88 so long as the socket member attachment 77 provides a similar shape so that a mating may be made between the male socket member 65 (orifice 88) and the socket member attachment 77 on the extension arm 24. Please also note that any other shape may be used for orifice 88, including but not limited to circles, ellipses, rectangles, squares, or any other polygon shape desired. However, providing a shape with a sharp edge is preferred so that the attachment device 26 does not rotate about the socket member attachment 77.

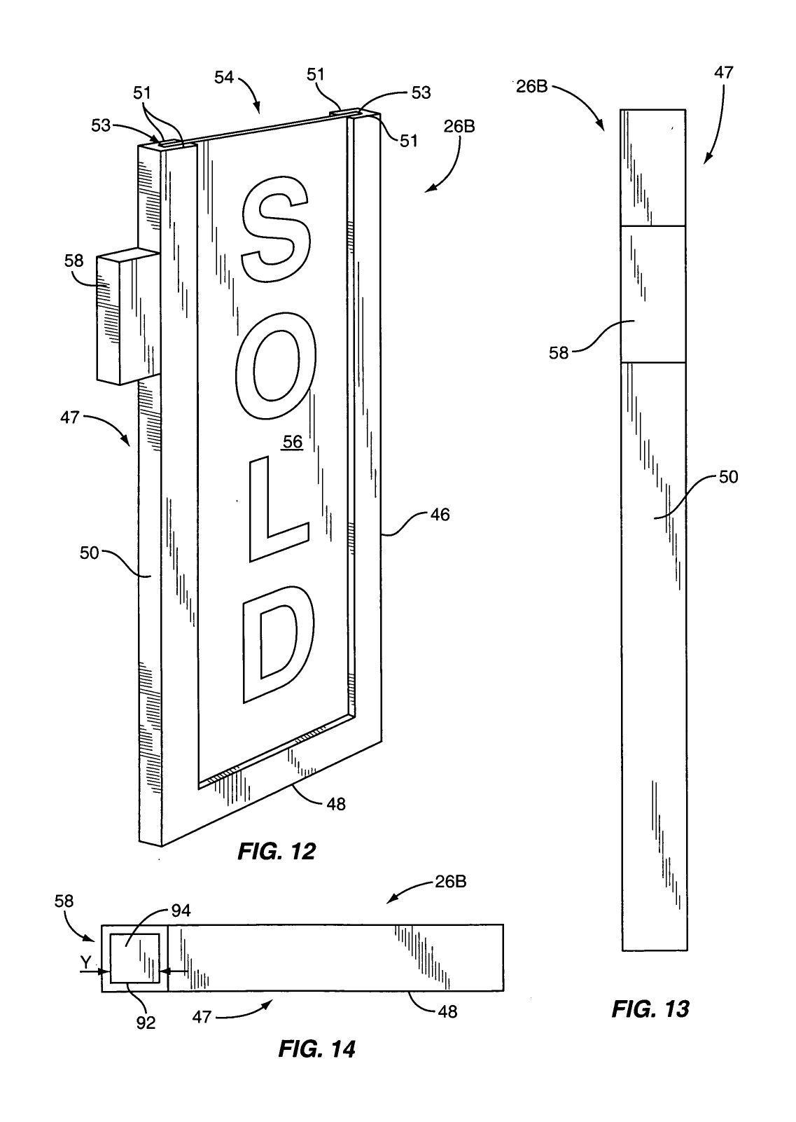

FIGS. 12 through 14 likewise show the socket member 58 used with the additional placard holder 26B. Before describing the socket member 58 and its characteristics, it is first desired to be noted that FIG. 12 illustrates the bent sections 51 of the left side 50 and right side 46 that form groove 53 as previously described above and like that for the bottom placard holder 32.

Socket member 58 is shown as attached to the left side 50 of the additional placard holder 26B; however, the socket member 58 may also be placed on the right side 46 or any other side of the additional placard holder 26B such that it can be mated and attached to the socket member attachment 77 of the extension arm 24. If the additional placard holder 26B is desired to be attached to the left side 50 of the real estate sign 10, like that of brochure box 26A as illustrated in FIG. 1, the socket member 58 may be placed and attached to the right side 46 of the additional placard holder 26B.

FIG. 13 illustrates a side view of the additional placard holder 26B on the side on which the socket member 58 is attached. FIG. 14 illustrates a bottom view of the additional placard holder 26B that illustrates the bottom side of the socket member 58. Just as provided for the socket member 65 of the brochure box 26A illustrated in FIG. 11, the socket member 58 of the additional placard holder 26B is formed by a square-shaped cylindrical perimeter of material 92 containing an orifice 94 having width ‘y.’ Just as previously described for FIG. 11 in the brochure box 26A, the additional placard holder 26B is attached and secured and supported by the real estate sign 10 by placing the orifice 94 onto the male member socket member attachment 77 of the extension arm 24. Again, because the socket member attachment 77 is placed inside the orifice 94, no external or additional fasteners or other attachment devices are required, thereby making it convenient in both ease and time savings to securely attach additional placard holder 26B to the real estate sign 10. Alternatively, note that the socket member attachment 77 could be a female member like orifice 94, and the socket member 58 could include an orifice like orifice 94 to attach the socket member 58 on the socket member attachment 77.

As previously described for the brochure box 26A in FIG. 11, the orifice 92 can take any shape desired so long as the shape is generally consistent with the shape of the socket member attachment 77 of the extension arm 24. Please note that the orifice 94 for the additional placard holder 26B could be of a different size and shape than the orifice 88 of the socket member 65 of the brochure box 26A. This would require possibly different sized socket member attachments 77 on the extension arms 24 of the real estate sign 10. In a preferred embodiment, however, the orifice sizes selected for orifices 94 and 88 will be the same so that the brochure box 26A and additional placard holder 26B can be used interchangeably with different real estate signs 10 and on different extension arms 24 on the same real estate sign 10. Note that if the additional placard holder 26B is desired to be attached on the left side instead of the right side of the real estate sign 10, the additional placard holder 26B can be reversed such that the socket member 58 is attached to the extension arm 24 on the left side of the real estate sign 10 as illustrated in FIG. 10; thereby making it possible in the present invention to install the brochure box 26A and the additional placard sign 26B on either side of the real estate sign 10 as desired.

Those skilled in the art will recognize improvements and modifications to the preferred embodiments of the present invention. All such improvements and modifications are considered within the scope of the concepts disclosed herein and the claims that follow.

What is claimed is:

1. A real estate sign, comprising:
a frame having three or more sides that are bent upward on each of the sides to form a groove for holding a main placard inside the frame;
at least one leg attached to the frame that supports the frame when the leg is inserted into the ground; and
at least one extension arm attached to one of the three more sides of the frame wherein the at least one extension arm comprises a socket member adapted to support an attachment device without any fasteners.

2. The sign of claim 1, wherein the at least one leg comprises two legs and further comprises a support member having two ends wherein one end is attached to one of the two legs, and the other end is attached to the other of the two legs.

3. The sign of claim 1, wherein the socket member is a male socket member.

4. The sign of claim 1, wherein the socket member is a female socket member.

5. The sign of claim 1, wherein the extension arm comprises an attachment section having two ends wherein the attachment section is attached to the frame on one end of the attachment section, and the attachment section is attached substantially perpendicular to a socket member on the other end of the attachment section.

6. The sign of claim 1, wherein the distance between the frame and the socket member is approximately 0.5 inches.

7. The sign of claim 1, wherein the at least one leg comprises two legs and further comprises a bottom placard holder having two ends wherein the first end is attached to one of the two legs and the other end is attached to the other of the two legs.

8. The sign of claim 7, wherein the bottom placard holder is comprised of:
a U-shaped frame, comprising:
a bottom side having two ends;
a left side that is attached to one of the bottom side ends; and
a right side parallel to the left side that is attached to the other of the bottom side ends;
wherein a slot is formed between the left side and the right side; and
wherein the left side is attached to one of the two legs and the right side is attached to the other of the two legs.

9. The sign of claim 8, wherein the bottom placard holder is attached to legs in a plane that is parallel to the plane between the two legs.

10. The sign of claim 8, wherein the bottom side, left side, and right side are each comprised of a rectangular strip that is bent inward on each side of the strip to form a groove adapted to hold a placard wherein the placard can be placed into the slot by placing the placard inside the groove between the left side and the right side.

11. The sign of claim 7, wherein the bottom placard holder is comprised of:
a built-in frame, comprising:
a bottom side having two ends wherein one end of the bottom side is attached to one of the legs and the other end of the bottom side is attached to the other leg;
a top side parallel to the bottom side having two ends wherein one end of the top side is attached to one of the legs and the other end of the top side is attached to the other leg; and
one or more U-shaped members attached to either one or more of the bottom side, top side, and legs wherein a bottom placard is inserted against the frame inside the one or more U-shaped members.

12. The sign of claim 11, wherein the bottom placard holder is attached to the legs in the same plane as the plane between the two legs.

13. The sign of claim 11, wherein the bottom side and the top side are each comprised of a rectangular strip that is bent inward on one side of the strip to form a groove adapted to hold a placard wherein the placard is placed inside the groove between the top side and the bottom side.

14. The sign of claim 1, wherein the frame is constructed out of a material comprised from the group consisting of metal, iron, steel, aluminum, and plastic.

15. The sign of claim 1, wherein the attachment device is an additional placard holder containing a socket member that is adapted to fit into the socket member attachment attached to the frame such that the frame supports the sign holder without any fastener.

16. The sign of claim 15, wherein the additional placard holder is comprised of:
a U-shaped frame comprising:
a bottom side having two ends;
a left side that is attached to one of the bottom side ends; and
a right side parallel to the left side that is attached to the other of the bottom side ends;
wherein a slot is formed between the left side and the right side.

17. The sign of claim 16, wherein the bottom side, left side, and right side are each comprised of a rectangular strip that is bent inward on each side of the strip to form a groove adapted to hold a placard wherein the placard can be placed into the slot by placing the placard inside the groove between the left side and the right side.

18. The sign of claim 15, wherein the width of the socket member attachment attached to the at least one extension arm is slightly smaller than the width of the socket member attached to the additional placard holder such that the additional placard holder is securely held in place to the at least one extension arm.

19. The sign of claim 15, wherein the width of the socket member attachment attached to the at least one extension arm is slightly larger than the width of the socket member attached to the additional placard holder such that the additional placard holder is securely held in place to the at least one extension arm.

20. The sign of claim 19, wherein the socket member attachment is molded into the left side of the frame.

21. The sign of claim 1, wherein the attachment device is a brochure box comprising a box having a front side and a back side attached together to form a cavity and containing a socket member that is adapted to fit into the socket member attachment attached to the frame such that the frame supports the brochure box without any fastener.

22. The sign of claim 21, wherein the socket member on the brochure box is located on the back side of the brochure box.

23. The sign of claim 21, wherein the back side is comprised of a top end and a bottom end wherein a lid is attached to the top end of the back side.

24. The sign of claim 23, further comprising a hinge attached to the back side wherein the lid is attached to the hinge to secure the lid to the brochure box.

25. The sign of claim 21, wherein the socket member is molded into the back side of the brochure box.

26. A brochure box for holding brochures that is adapted to be attached onto an extension arm of a real estate sign without fasteners, comprising:
a front side;
a back side having a top end and a bottom end wherein the front side and back side are attached together to form a cavity;
a lid attached to the top end of the back side to cover the cavity wherein the lid closes access to the cavity and wherein the cavity is accessible by lifting the lid; and
a socket member attached to the back side wherein the socket member is adapted to be inserted onto the extension arm of the real estate sign to secure the brochure box to the real estate sign without fasteners.

27. The box of claim 26, further comprising a hinge attached to the back side wherein the lid is attached to the hinge to secure the lid to the brochure box.

28. The box of claim 26, wherein the socket member is molded into the back side.

29. The box of claim 26, wherein the socket member is a female socket member.

30. The box of claim 26, wherein the socket member is a male socket member.

31. A placard sign holder that is adapted to hold a placard and be attached onto an extension arm of a real estate sign without fasteners, comprising:
a U-shaped frame, comprising:
a bottom side having two ends;
a left side that is attached to one of the bottom side ends; and
a right side parallel to the left side that is attached to the other of the bottom side ends;
wherein a slot is formed between the left side and the right side; and
wherein the bottom side, left side, and right side are each comprised of a rectangular strip that is bent inward on each side of the strip to form a groove adapted to hold the placard wherein the placard can be placed into the slot by placing the placard inside the groove between the left side and the right side; and
a socket member attached to either the left side or right side adapted to be inserted onto the extension arm of the real estate sign to secure the placard sign holder to the real estate sign without fasteners.

32. The holder of claim 31, wherein the socket member is molded into either the left side or right side.
